(19) United States
(12) Patent Application Publication
(10) Pub. No.: US 2005/0086142 A1
(43) Pub. Date: Apr. 21, 2005

(54) Lease guaranty business model

(75) Inventors: Jeffrey Geller, New York, NY (US); Robert M. Rosenberg, Scarsdale, NY (US); Richard S. O'Connell, Morristown, NJ (US); Paul C. Schack, New York, NY (US)

Correspondence Address: PILLSBURY WINTHROP, LLP, P.O. BOX 10500, MCLEAN, VA, 22102, US

(73) Assignee: RS Reinsurance (Bermuda) Ltd., New York, NY (US)

(21) Appl. No.: 10/684,702

(22) Filed: Oct. 15, 2003

(51) Int. Cl. G06F 17/60

(52) U.S. Cl. 705/35

(57) ABSTRACT

Methods are provided for lease guaranty services. A landlord enters into an arrangement with a lease guaranty service provider including an agreed upon lease guaranty policy to cover a rental property associated with the landlord. Under the lease guaranty policy, the landlord is a beneficiary and is bound to some contractual duties. A tenant, interested in renting the rental property, enters into a lease guaranty participation agreement with the lease guaranty service provider, which provides that the lease guaranty service provider pays the landlord a claim amount, resulted from the tenant's failure to comply with a lease signed between the tenant and the landlord for the rental property, and the tenant is legally liable to the lease guaranty service provider.

### BACKGROUND

1. Field of Invention

The inventions described herein relate to methods and systems to provide real estate lease guaranty and to systems incorporating the methods.

2. Discussion of Related Art

Real estate rental has been conventionally handled through a lease signed between a landlord and a tenant with contractual terms such as a duration of the leasehold, an agreed rent amount per unit period, and a security deposit during the leasehold. The duration may be five years, one year, one half year, or even one month. The rent amount may be defined with respect to a unit period of, for example, one month. Other contractual duties with respect to each involved party may also be specified in the lease.

Normally, a lease binds a landlord and tenant to fulfill the specified contractual duties. Through the lease, the landlord is entitled, for example, to payment of a specified rent for every unit period, a security deposit, during the leasehold, and an apartment returned without damage (other than normal wear and tear) at the end of the leasehold. At the same time, the landlord may have certain contractual duties to fulfill. Such landlord's duties may be explicitly specified in the lease such as to provide utilities. Landlord's duties may also be required by law such as meeting the standard of habitability according to local housing code or to ensure the tenant's quiet enjoyment of the leased property.

As a result of entering into a lease agreement with the landlord the tenant has the right of possession of the leased real estate during the specified term. The tenant has the duty to pay rent. In addition, the tenant may be required to satisfy other contractual duties, including the duties explicitly specified in the lease as well as the duties implicitly required by law. For instance, a lease may explicitly specify that the tenant may not have any pet in the leased property. Laws may also require that a tenant maintain reasonable repair of the leased property during the lease term.

Traditionally, a signed lease is a contractual agreement that serves as an instrument to enforce each party to fulfill certain contractual duties. When a party breaches the contract or when a dispute arises, either party may resort to court action to enforce its rights. For instance, if the landlord fails to meet local housing code, the tenant may request remedy through the court. When a tenant fails to pay rent as agreed or breaches the lease for another reason, the landlord may go to the court to compel the tenant to pay rent, cure the breach, or evict the tenant. Frequently, when a tenant breaches, the landlord will incur substantial loss, which may include both monetary loss such as rent and non-monetary loss such as damages to the involved real estate property. Even when the court affords a remedy to the landlord, the total cost of bringing the dispute to an end may nevertheless exceed the remedy.

To prevent or minimize potential loss, a landlord may adopt various strategies. A landlord may demand a high security deposit with the signing of a lease agreement. A landlord may also require that a potential tenant be “qualified” by having a certain level of income and/or credit rating. When a potential tenant does not meet some of the landlord's requirements, a landlord may require a co-signer or guarantor to the lease. While such strategies are used to address landlords' reasonable concerns, they may impose significant burden on potential tenants. Some potential tenants may have perfect credit but fail to meet the income level requirement. Some may have high income yet without adequate credit history. Although these potential tenants may be reliable and trustworthy, they are nevertheless denied housing opportunities without fault.

### BRIEF DESCRIPTION OF THE DRAWINGS

The inventions claimed and/or described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 depicts an exemplary framework in which a lease guaranty service provider offers services in a real estate rental market, according to an embodiment of the inventions;

FIG. 2(a) is an exemplary overall flow of a business process, in which a lease between a landlord and a tenant is guaranteed through a lease guaranty service, according to a first embodiment of the inventions;

FIG. 2(b) is an exemplary overall flow of a business process, in which a lease between a landlord and a tenant is guaranteed through a lease guaranty service, according to a second embodiment of the inventions;

FIG. 3 is a flow of an exemplary business process, in which a landlord signs up for a lease guaranty policy with a lease guaranty service provider, according to an embodiment of the inventions;

FIG. 4 is a flow of an exemplary business process, in which a tenant's application for a lease guaranty pre-authorization is processed, according to an embodiment of the inventions;

FIG. 5 is a flow of an exemplary business process, in which a tenant's application for a lease guaranty participation agreement is processed, according to an embodiment of the inventions;

FIG. 6 is a flow of an exemplary business process, in which a landlord performs contractual duties under a lease guaranty policy, according to an embodiment of the inventions;

FIG. 7 is a flow of an exemplary business process, in which a lease guaranty service provider processes a claim in compliance with a lease guaranty policy and a lease guaranty participation agreement, according to an embodiment of the inventions; and

FIG. 8 is a flow of an exemplary business process, in which a lease guaranty service provider processes a tenant's application to renew a lease guaranty participation agreement, according to an embodiment of the inventions.

### DETAILED DESCRIPTION

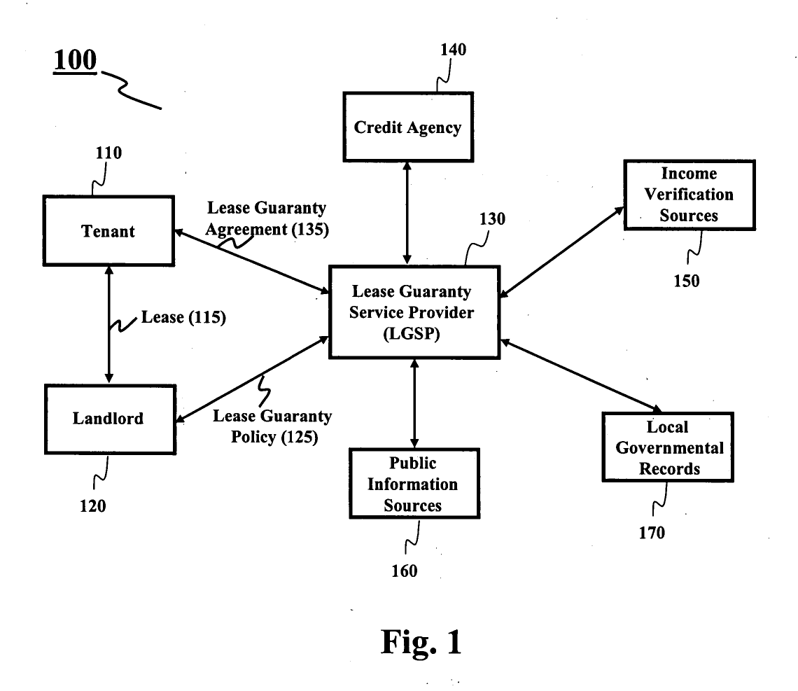

FIG. 1 depicts an exemplary framework 100 in which a lease guaranty service provider offers lease guaranty services in a real estate rental market, according to an embodiment of the inventions. The framework 100 comprises a tenant 110, a landlord 120, a lease guaranty service provider (LGSP) 130, and a plurality of information sources (e.g., a credit agency 140, an income verification source 150, public information sources 160, local governmental records 170, or various banking information sources 180), from where the LGSP 130 may obtain or verify information about the landlord 120 and the tenant 110.

In the framework 100, the landlord 120 and the tenant 110 enter into a lease (115) because of a lease guaranty service provided by the LGSP 130. The landlord 120 first requests to obtain a lease guaranty policy (125) from the LGSP 130 with respect to one or more rental properties associated with the landlord 120. The landlord 120 may be the owner of such covered rental property. The landlord 120 may also be a management service provider hired by the owner of the rental property to manage the rental property. The lease guaranty policy 125, which may cover all, some, or one of landlord's properties, ensures the landlord 120 that the lease terms defined in a lease signed between the landlord 120 and a tenant with regard to a rental property are guaranteed. Such terms may include, but are not limited to, rent, damages to the rental property, or cost of replacing the tenant in case of early termination. Terms covered by a lease guaranty policy may vary, depending on the contractual agreement between the landlord 120 and the LGSP 130. Under this policy, the landlord 120 is an insured or a beneficiary.

To process a request for a lease guaranty policy from the landlord 120, the LGSP 130 may qualify the landlord 120 based on information from different information sources. For example, the LGSP 130 may check with a local department of housing (170) to see whether there is any record associated with the landlord 120 for violation of the local housing code concerning the rental property to be covered under the policy in a predetermined period of time (e.g., last three years). The LGSP 130 may also obtain information from other public information sources (160) such as the local court system to check whether there is any pending dispute against the landlord 120. If such check yields a favorable result (e.g., there is no record indicating that the landlord 120 is involved in any violation or dispute), the LGSP 130 may approve the landlord's request and issue a lease guaranty policy to the landlord 120.

There may be conditions specified in a lease guaranty policy that must be satisfied before the landlord 120 may file a claim under the policy. For example, the landlord 120 may be bound to one or more contractual duties that have to be performed prior to filing a claim. In addition, it may be required that the landlord 120 be at no fault in the dispute which gave rise to the claim. Furthermore, the landlord 120 may be required to be free of any record that indicates any violation of the local housing code on the rental property concerned.

The lease guaranty policy may also require that pre-defined contractual duties be performed prior to filing a claim with the LGSP 130. Such contractual duties may include that the landlord 120 has to i) notify the tenant of any breach (e.g., non-payment of rent) within a pre-determined period after the tenant defaults; ii) initiate, if the tenant fails to correct the default situation (e.g., the tenant still does not pay rent) after the first notification, an eviction proceeding in a court; and iii) submit a claim amount based on either the court order resulting from the eviction proceeding or a settlement between the landlord 120 and the tenant 110.

A lease guaranty policy may be issued in different forms. For example, it may be issued in a form much like an insurance policy. It may also be issued in other forms. For instance, the policy may be issued as a surety bond. In the latter case, the policy may be called a lease surety bond. Although issued in different forms, a lease guaranty policy and a lease surety bond may provide the same coverage. The landlord 120 or the LGSP 130 may specify the preferred form in which lease related guaranty is provided.

The scope of each lease guaranty policy (or lease surety bond) may vary. Different coverages may correspond to different combinations of related lease terms such as rent, damages to relevant real properties, or a replacement tenant following an early termination (e.g., early eviction of the tenant). For instance, a lease guaranty policy may cover only rent. In this case, the landlord 120 is entitled to recover only rent loss from the LGSP 130 in case of tenant's default. A different policy may cover both rent loss and property damages. Yet another policy may cover a different combination of rent and the tenant replacement in case of an early termination.

Choices of different coverage may depend on the landlord's preference suitability or the discretion of the LGSP 130. Such choices may be made based on a variety of factors such as the character of property, the past experience that the landlord 120 has in the rental market. The coverage may also be specified to vary with each lease signed for the rental properties covered under the policy.

A policy may specify the conditions associated with each choice of the coverage. For instance, a policy may indicate to elect a coverage of rent only when the tenant has an income lower than a desired level but has a good credit history or to elect a coverage of both rent and property damage when the tenant has a record indicating bad behavior towards rental properties. With such conditions set forth in a lease guaranty policy, a coverage associated with a particular rental property is not fixed until a tenant signs a lease with the landlord.

Certain limitations may apply to specific terms covered under a lease guaranty policy. For example, a claim to property damage may be limited to a certain dollar amount (e.g., $5,000). A claim related to tenant replacement may require that the landlord 120 is not at fault. For instance, if the landlord 120 evicted the tenant 4 months prior to the agreed lease term expires (e.g., one year lease) due to tenant's violation of no-pet policy, the landlord 120 is a no-fault party. Other no-fault early eviction may be caused by complaints of neighbors about the tenant's nusiance (e.g., loud music). When the landlord 120 satisfies the conditions set forth in relevant lease guaranty policy (or lease surety bond), the landlord 120 is entitled to file a claim to recover from the LGSP 130.

In the framework 100, the tenant 110 is a party who is interested in renting or rents a rental property covered under a lease guaranty policy (or lease surety bond) associated with the landlord 120. To obtain a lease on a rental property of interest, the tenant 110 requests to enter into a lease guaranty participation agreement 135 with the LGSP 130. Alternatively, the landlord 120 may make the same request on behalf of the tenant 110. The LGSP 130 may first qualify the tenant 110 based on information from different sources. For example, the LGSP 130 may check the credit of the tenant 110 with the credit agency 140. In addition, it may also verify the tenant's income with different income verification sources 150. If such checks yield a positive result in favor of the tenant 110, the LGSP 130 approves the tenant's application for the lease guaranty participation agreement.

Under a lease guaranty participation agreement, the tenant 110 or the landlord 120 may be required to pay a fee to the LGSP 130 to obtain lease guaranty service covering the term of the lease (e.g., one year). The lease guaranty participation agreement may provide that in an event in which the landlord 120 files a claim with a claim amount, resulting from the tenant's failure to comply with certain terms of the lease (e.g., fails to pay rent or cause damages to the rental property) and the LGSP 130 pays the landlord 120 the claim amount in compliance with a lease guaranty policy (or lease surety bond) under which the involved rental property is covered, the tenant 110 is liable to the LGSP 130 for the amount paid by the LGSP 130 to the landlord 120.

The tenant 110 may apply for a lease guaranty participation agreement for various reasons. The tenant 110 may not completely qualify to enter into a lease with the landlord 120. For example, the landlord 120 may require a potential tenant to have a very high income and a very high credit rating. The tenant 110 may have a satisfactory income but have no credit history (resulting in a low credit evaluation) or the tenant 110 may have a good credit history but an income that is not as high as what the landlord 120 asks for. Alternatively, the tenant 110 may be a foreigner who needs a temporary residence in the area for business reasons and whose rent is paid by his employer but on the record, the tenant satisfies none of the landlord's requirements. In those situations, the LGSP 130 may provide a useful service to both the landlord 120 and the tenant 110.

In the framework 100, the LGSP 130 may act on behalf of an insurer. It may qualify the landlord 120 for a lease guaranty policy covering one or more rental properties and insures different terms of the lease under such a policy. At the same time, it may qualify a tenant, for a fee, to enter into a lease guaranty participation agreement, which, while agreeing to provide coverage, with respect to certain terms of a lease (e.g., rent and property damage), to the landlord 120, assigns a claim amount, resulting from the tenant's breach, to the LGSP 130. With this service, a lease between the tenant 110 and the landlord 120 is effectuated with the presence of both the lease guaranty policy (or lease surety bond) between the landlord 120 and the LGSP 130 and the lease guaranty participation agreement between the tenant 110 and the LGSP 130.

Under such contractual relationships among three parties (the tenant 110, the landlord 120, and the LGSP 130), when the tenant 110 breaches any terms covered under the lease guaranty policy, if the landlord 120 fulfills his/her contractual duties and conditions specified in the lease guaranty policy, the landlord 120 is entitled to file a claim to recover loss from the LGSP 130 and the tenant 110 becomes legally liable to the LGSP 130 for the amount paid to the landlord 120. The claim amount may be determined in different ways, depending on how the dispute is resolved. For example, a court judgment from an eviction proceeding initiated by the landlord 120 may be used as the claim amount. Alternatively, if the tenant 110 and the landlord 120 reach a settlement, the settlement amount agreed between the two parties may correspond to the claim amount.

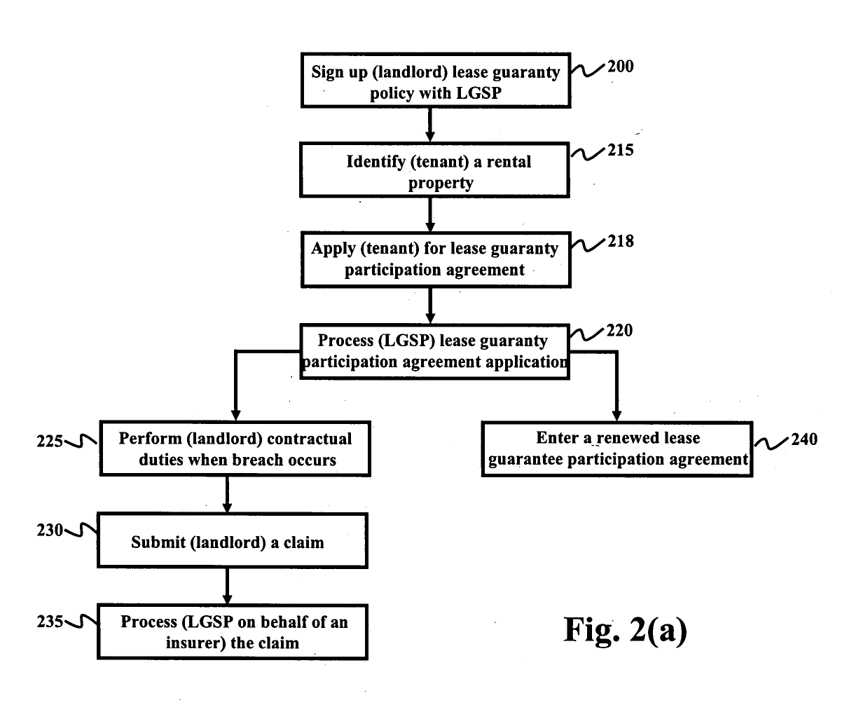

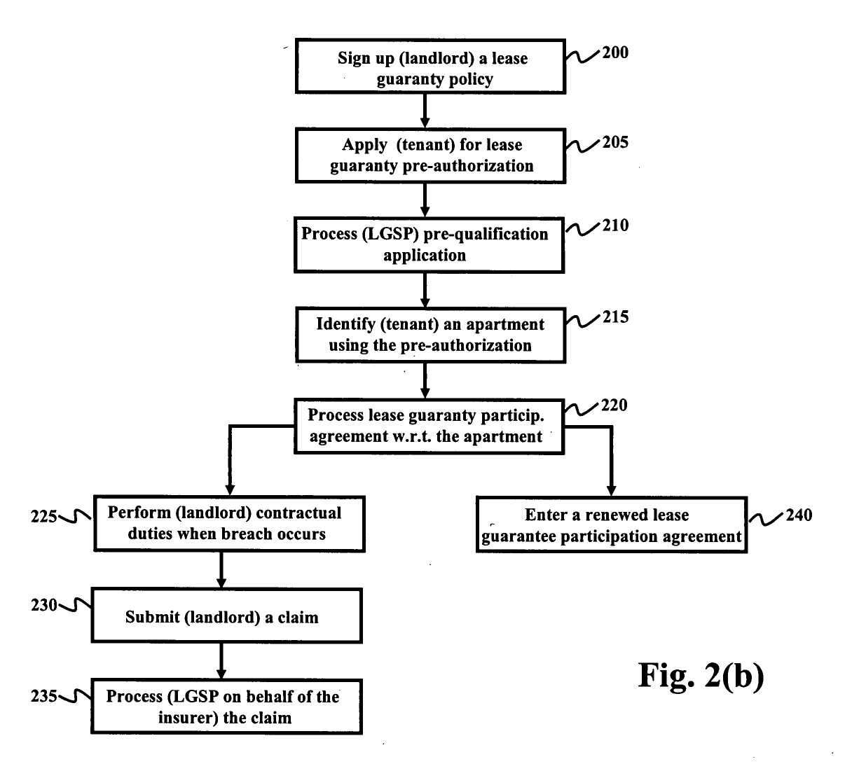

FIGS. 2(a) and 2(b) present overall process flows according to different embodiments of the inventions. FIG. 2(a) is an exemplary overall flow of a business process, in which a lease between a landlord and a tenant is guaranteed through a lease guaranty service, according to a first embodiment. The landlord 120 first signs up, at act 200, for a lease guaranty policy with the LGSP 130. The sign-up process involves application, application processing, and issuance of the policy performed by the landlord 120 and the LGSP 130. Details related to this process are described with reference to Fig.. 3.

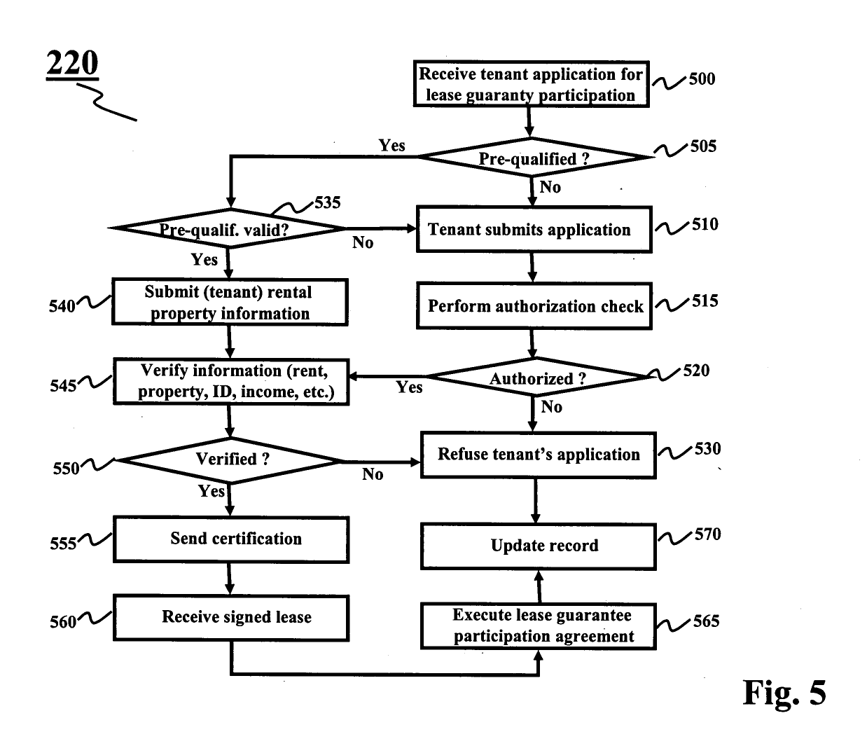

After the landlord 120 obtains a lease guaranty policy from the LGSP 130, the tenant identifies, at act 215, a rental property to rent that is associated with the landlord 130 and covered under the lease guaranty policy. To obtain a lease, the tenant 110 applies, at act 218, for a lease guaranty participation agreement from the LGSP 130 with respect to the identified rental property. Alternatively, the landlord 120 may make the same request on behalf of the tenant 110. Upon receiving the request, the LGSP 130 processes, at act 220, the lease guaranty participation agreement application. Such processing may include approving the application, issuing necessary documentation upon approval, entering the agreement, and the execution of the agreement. Details related to this process are described with reference to FIG. 5.

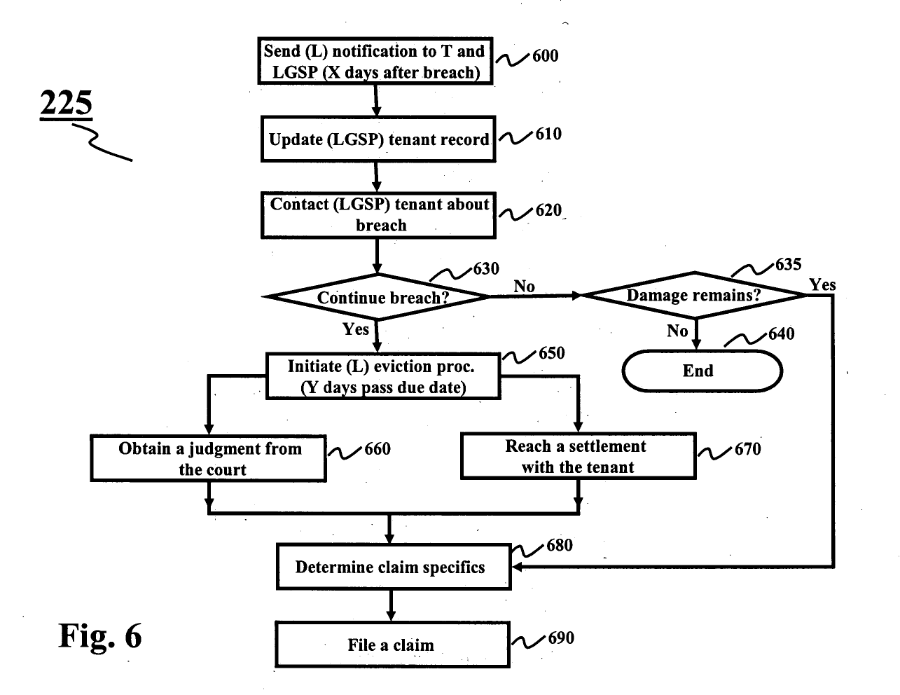

If the tenant 110 breaches certain terms in the lease that are covered under the corresponding lease guaranty policy after the tenant 110 and the landlord 120 enter into a lease and the tenant 110 and the LGSP 130 enter into a lease guaranty participation agreement, then the landlord 120 performs, at act 225, contractual duties defined in the lease guaranty policy covering the rental property. Details about contractual duties performed are described with reference to FIG. 6. After fulfilling all the conditions that qualify the landlord 120 for a claim, the landlord 120 submits, at act 230, a claim to the LGSP 130.

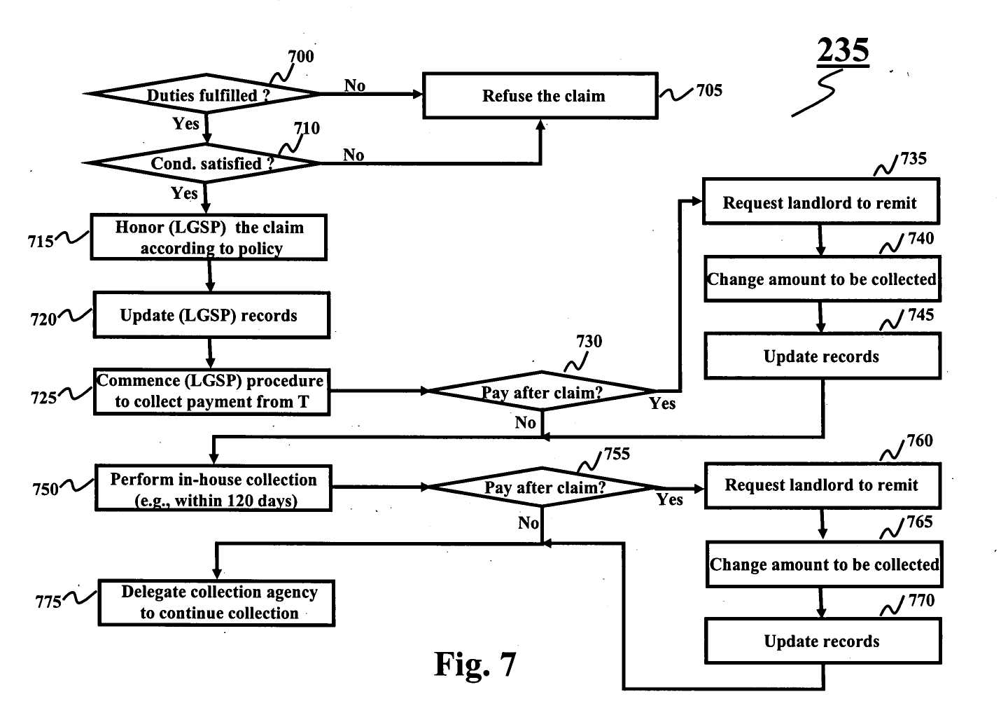

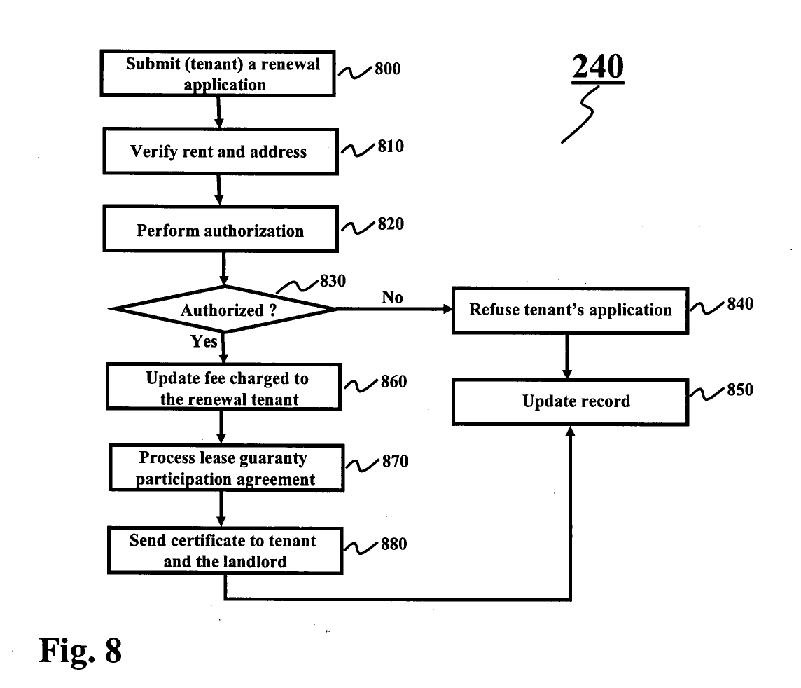

Upon receiving the claim from the landlord 130, the LGSP 130 then processes, at act 235, the claim, on behalf of an insurer, in compliance with the lease guaranty policy issued to the landlord 120 and the lease guaranty participation agreement (with the tenant 110). Details about how the LGSP 130 processes a claim are described with reference to FIG. 7. When no default occurs during a lease term, the tenant may request to renew, at act 240, the lease guaranty participation agreement with the LGSP 130. Details related to the renewal process are described with reference to FIG. 8.

FIG. 2(b) is a different exemplary overall flow of a business process, in which a lease between a landlord and a tenant is guaranteed through a lease guaranty service, according to a second embodiment of the inventions. This exemplary business process, illustrated in FIG. 2(b), involves substantially the same acts as the exemplary business process described in FIG. 2(a) except that the tenant 110 may obtain a lease guaranty pre-authorization from the LGSP 130 prior to identifying a rental property and such a pre-authorization may be used by the tenant 110 in securing a rental property.

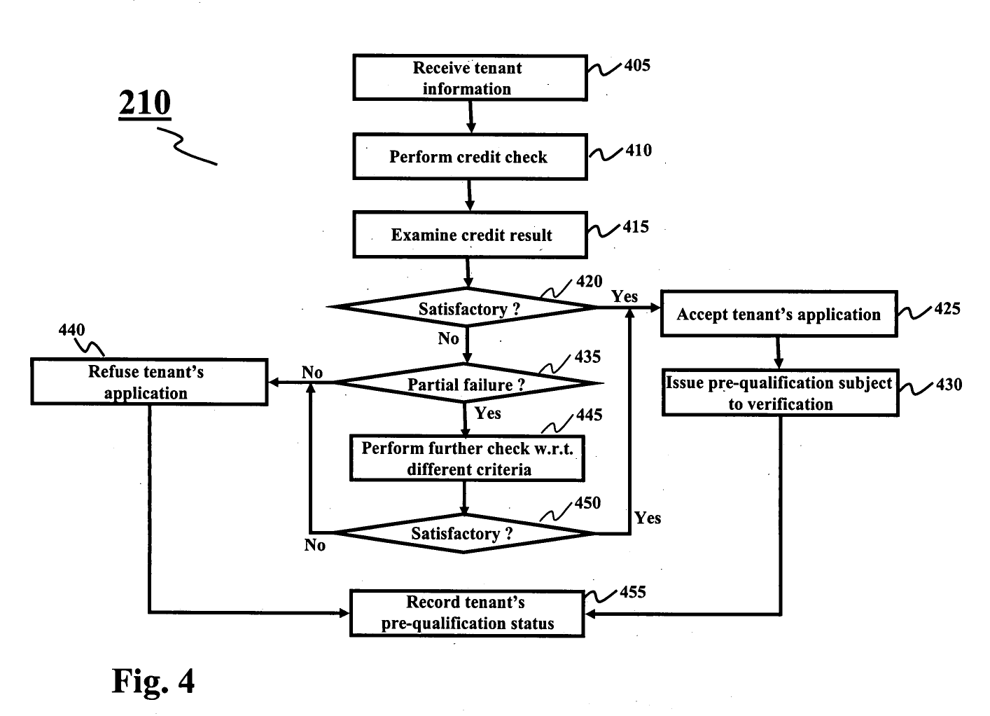

Similar to the first exemplary business process, the landlord 130 first signs up, at act 200, for a lease guaranty policy from the LGSP 130. The tenant applies, at act 205, for a lease guaranty pre-authorization from the LGSP 130. The LGSP 130 then, upon receiving the lease guaranty pre-authorization application from the tenant 110, processes, at act 210, the tenant's application to determine whether such a pre-authorization is to be issued to the tenant 110. To issue a pre-authorization, the LGSP 130 may perform various qualification checks in order to approve the application. Such a pre-authorization issued to the tenant 110 may help the tenant 110 to secure a leasehold. Details related to the issuing process of the applied pre-authorization are described with reference to FIG. 4.

After the tenant 110 is issued a lease guaranty pre-authorization, the tenant 110 identifies, at act 215, a rental property of interest. The tenant 110 may use the issued lease guaranty pre-authorization as an indication of credibility in securing the rental property. With the identified rental property, the tenant 110 may then apply to enter into a lease guaranty participation agreement with the LGSP 130. Alternatively, the landlord 120 may require that the tenant 110 enter into such an agreement before a lease can be signed. When the LGSP 130 receives the tenant's application for a lease guaranty participation agreement, the LGSP 130 processes, at act 220, the application to determine whether it is to be approved.

The tenant 110 and the landlord 120 may enter into a lease of a specified term (e.g., one year) with respect to the identified rental property after the LGSP 130 issues a certificate of the lease guaranty participation agreement. During the lease term, when the tenant 110 breaches the lease, the landlord 120 performs, at act 225, contractual duties defined in the corresponding lease guaranty policy covering the rental property. The landlord 120 then, after fulfilling the conditions that qualify the landlord 130 for a claim, submits, at act 230, a claim to the LGSP 130.

Upon receiving the claim from the landlord 130, the LGSP 130 then processes, at act 235, the claim, on behalf of an insurer, in compliance with the lease guaranty policy held by the landlord 120 and the lease guaranty participation agreement (with the tenant 110). When there is no breach during the lease term, the tenant may request (e.g., near the end of the lease term) to renew, at act 240, the lease guaranty participation agreement with the LGSP 130 for another term, if the tenant 110 intends to renew the lease.

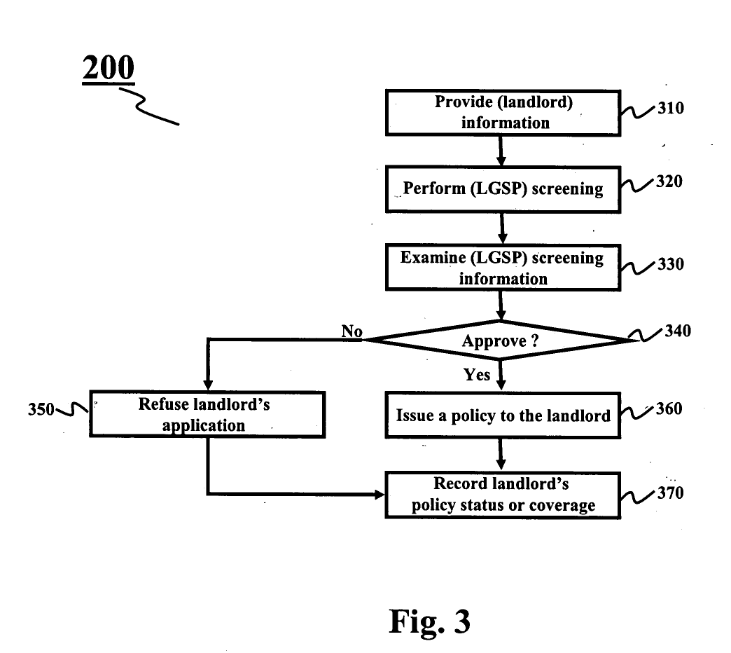

Details related to various acts described in the above two different embodiments of lease guaranty service business processes are discussed below. FIG. 3 is a flow of an exemplary business process (200), in which the landlord 120 signs up for a lease guaranty policy (or lease surety bond) with the LGSP 130, according to an embodiment of the the inventions. To obtain a lease guaranty policy, the landlord 120 first provides, at act 310, relevant information to the LGSP 130. Such information may include the identity of the landlord 120, the rental property to be covered under the policy, etc. The information may also include the elected coverage offered by the LGSP 130 or preferred by the landlord 120. For example, the LGSP 130 may simply elect to cover the rent, or property damages, or both. Such elected coverage may have a relation to the fee to be charged to the tenant 110 to enter into a corresponding lease guaranty participation agreement. Upon receiving the landlord's request for such a policy, the LGSP 130 may perform, at act 320, certain screening with respect to the landlord 120, the rental property concerned, or both.

The screening may be performed by examining, for example, whether the landlord 120 has any recorded violation of local housing code in a predetermined period of time (e.g., the last three years). Such information may be identified from different public information sources such as the court's records (e.g., any legal proceedings related to either the landlord or the rental property), the local commerce department (e.g., for tenant's complaints), or the local health department (e.g., an inspection report indicating a violation of relevant housing code). Such screening information is then examined, at act 330, to determine, at act 340, whether the landlord's application for a lease guaranty policy is to be approved.

If the screening result yields a negative result (i.e., not approved), the LGSP 130 refuses the landlord's application at act 350. Such refusal is accordingly recorded at act 370. Otherwise, the LGSP 130 issues, at act 360, a lease guaranty policy to the landlord with respect to the rental property associated with the policy. As discussed earlier, the policy may be issued in different forms such as a lease surety bond. The LGSP 130 then records, at act 370, the status of the landlord's policy and its coverage.

FIG. 4 is a flow of an exemplary business process (210), in which the tenant's application for a lease guaranty pre-authorization is processed, according to an embodiment of the inventions. The pre-authorization may be performed by an authorizer, which may be the LGSP 130 or, alternatively, by an insurer such as an insurance company. The authorizer first receives, at act 405, relevant information from the tenant 110. The authorizer may request such information in order to determine whether the tenant 110 is qualified for such a pre-authorization. For example, such information may include the tenant's identity (e.g., name, social security number), income, employer, bank account, etc.

With the relevant information received from the tenant 110, the authorizer performs, at act 410, a credit check. The returned result on the credit check is examined at act 415. If the credit of the tenant 110 is satisfactory, determined at act 420, the authorizer accepts, at act 425; the tenant's application for lease guaranty pre-authorization and issues, at act 430,, the lease guaranty pre-authorization to the tenant 110. In some situations, such issued pre-authorization may indicate that a full approval is subject to verification of certain information. The types of information that may be subject to verification includes income or employment. The assurance of the pre-authorization to the tenant's is then recorded at act 455.

If the credit check result is not satisfactory, determined at act 420, the authorizer may further determine, at act 435, whether it is completely unsatisfactory. If it is completely unsatisfactory, the authorizer refuses, at act 440, the tenant's application for a lease guaranty pre-authorization. Such refusal status is then recorded at act 450. If the credit check is only partially unsatisfactory, determined at act 435, the authorizer may further carry out other checks, at act 445, according to different criteria. For example, if the tenant 110 is a foreign person and had no credit record at all in this country, the authorizer may resort to other measures such as whether the rent will be paid by the tenant's employer as a business expense. As another example, the tenant's credit check may not result in a required level but is higher than a low threshold (for rejection), the authorizer may further check whether the tenant 110 has enough saving or assets.

If the further check yields a positive result, determined at act 450, the authorizer accepts the tenant's application, at act 425, and issues, at act 430, the lease guaranty pre-authorization, which may be specified as subject to further verification of certain information. The issuance of the tenant's pre-authorization is then accordingly recorded at act 455. If the further check performed at act 445 yields a negative result, the authorizer refuses the tenant's application, at act 440, and records the refusal status at act 455.

FIG. 5 is a flow of an exemplary business process (220), in which the tenant's application for a lease guaranty participation agreement is processed, according to an embodiment of the inventions. Considering the two different embodiments described in FIG. 2(a) and 2(b), when the tenant 110 applies to enter into a lease guaranty participation agreement with respect to a particular rental property, the tenant 110 may or may not have a previously issued lease guaranty pre-authorization. Therefore, when the LGSP 130 receives, at act 500, the tenant's application for a lease guaranty participation agreement, the LGSP 130 first determines, at act 505, whether the tenant 110 has a previously issued lease guaranty pre-authorization.

If the tenant 110 has a previously issued pre-authorization, the LGSP 130 further checks, at act 535, whether the pre-authorization is still valid. A lease guaranty pre-authorization may be specified to remain valid for only a predetermined period (e.g., one month). If the previously issued pre-authorization is still valid, the tenant 110 submits, at act 540, information related to the rental property. This may be necessary because the tenant 110 may have obtained the previously issued pre-authorization without a specific rental property identified at the time while a lease guaranty participation agreement is with respect to a particular rental property.

When a lease guaranty pre-authorization is issued subject to further verification, the LGSP 130 verifies, at act 545, various information with different sources in order to approve the tenant's application to enter into a lease guaranty participation agreement. Information to be verified may include, but is not limited to, the rental property which the lease guaranty participation agreement covers, the amount of rent intended, identification of the tenant 110, income of the tenant 110, employment, etc. The verification status is then checked at act 550. If the verification is not successful, the LGSP 130 refuses, at act 530, the tenant's request to enter into a lease guaranty participation agreement. Such refusal is accordingly recorded at act 570 and if necessary or desired, issue a notice to the tenant setting forth such refusal.

If the verification is successful, the LGSP 130 issues a certificate, at act 555, to indicate the approval from the LGSP 130 to enter into a lease guaranty participation agreement with the tenant 110. Such a certificate may be issued to both the tenant 110 and the landlord 120. It may be necessary because the landlord 120 may require the tenant 110 to obtain a lease guaranty participation agreement on the rental property prior to signing the lease. Issuing a certificate indicating that the tenant's application for a lease guaranty participation agreement is to satisfy the landlord's requirement. The tenant 110 may then present the certificate to the landlord 120 and based on that the parties may then sign the lease with respect to the rental property. Upon the successful verification, the lease guaranty participation agreement is executed at 557.

Once the tenant 110 and the landlord 120 sign the lease, a copy of the lease may be sent to the LGSP 130. Upon receiving the signed lease, at act 560, the rider is then forwarded, at 565, to the lease guaranty policy that the landlord 120 holds. Records associated with both the tenant 110 and the landlord 120 may then be accordingly updated at act 570.

If the tenant 110 does not have a valid lease guaranty pre-authorization previously issued (either never had one or had one but it expired), determined at acts 505 or 535, the tenant 110 submits a request and relevant information, at act 510, to be used to process the lease guaranty participation agreement application. Based on the information provided by the tenant 110, the LGSP 130 conducts, at act 515, an authorization check on the tenant 110. This procedure may constitute the same checks as what is performed in approving a lease guaranty pre-authorization application (described with reference to FIG. 4).

If the pre-authorization check yields a negative result, determined at act 520, the LGSP 130 refuses, at act 530, the tenant's application for a lease guaranty participation agreement. Such refusal status is then recorded at act 570.

If the pre-authorization check yields a positive result, the LGSP 130 proceeds further for information verification at act 545. As discussed earlier, the tenant's application for the lease guaranty participation agreement is approved only if the verification is successful, determined at act 550. Similarly, when the LGSP 130 approves the application for the agreement, a certificate may be issued, at act 555, to both the tenant 110 and the landlord 120 and the lease guaranty participating agreement is executed at 557. With the certificate, the landlord 120 and the tenant 110 sign the lease on the involved rental property and a copy of the lease is sent to the LGSP 130 in order to effectuate the lease guaranty participation agreement. Once a copy of the signed lease is received, at act 560, then the rider is forwarded, at 565, to the lease guaranty policy. Subsequently, various records are updated at 570.

FIG. 6 is a flow of an exemplary business process (225), in which the landlord 120 initiates contractual duties in compliance with a lease guaranty policy, according to an embodiment of the inventions. When the tenant 110 breaches (e.g., the tenant 110 fails to pay rent or tenant 110 damaged the rental property), the landlord 120 first sends, at act 600, the tenant 110 a notification, indicating the breach and demand for remedy (e.g., request the tenant 110 to pay late rent or demand the tenant 110 to pay the cost of repairing the damaged property). The landlord 120 may also be required to send the LGSP 130 the same notification, which puts the LGSP 130 on notice of the tenant's breach. The lease guaranty policy may require that the landlord 120 send the notifications within a certain number of days after the breach is observed (e.g., 10 days after the rent due date or 15 days after the landlord 120 observed or is notified of the damage to the rental property).

When the LGSP 130 receives the notification from the landlord 120, it may update, at act 610, its records to log the breach. The update may be performed to both the tenant's record and the landlord's record. At this point, the LGSP 130 may independently contact, at act 620, the tenant 110 about the tenant's breach. If the tenant 110 corrects the wrong doing (e.g., pays the late rent or pays the lost repairing the property damages) within a predetermined period after the tenant 110 receives the notifications (from both the landlord 120 and the LGSP 130), determined at act 630, the landlord 120 further determines, at act 635, whether the remedy provided by the tenant 110 is adequate.

If the tenant 110 adequately remedies the loss caused by the breach, the process ends at act 640. That is, in this case, the landlord 120 does not pursue a claim. Otherwise, the landlord 120 is entitled to file a claim for the remaining damages (e.g., either partial rent or loss due to damaged property). In this case, the landlord 120 determines, at act 680, the specifics of a claim to be filed (e.g., amount of damages) and then accordingly prepares and files the claim under the lease guaranty policy with the LGSP 130 at act 690.

If the tenant 110 does not act to cure the breach for the pre-determined period after the tenant 110 receives the notifications, the landlord 120 initiates, at act 650, an eviction proceeding in a court. The lease guaranty policy may provide some specific provision(s) regarding a time frame during which the landlord 120 has to initiate this legal proceeding (e.g., 45 days after the first notification of the breach). After the eviction proceeding is initiated, the landlord 120 may wait until the landlord 120 obtains, at act 660, a judgment from the court where the eviction proceeding is initiated. The judgment may specify a monetary amount that the landlord 120 is entitled to.

Alternatively, during the interim of the eviction proceeding, the tenant 110 and the landlord 120 may reach a settlement, at act 670, by which the tenant 110 agrees to pay some monetary amount to the landlord 120. This may occur, for example, when the tenant 110 surrenders the rental property earlier than what is agreed in the lease (e.g., lease is for one year but the tenant 110 moves after the first three months) or when the tenant 110 accepts the responsibility of repairing the damage to the property. In such situations, the tenant 110 may reach a settlement with the landlord 120, by which the tenant 110 agrees to pay for the loss occurred due to his breach. For instance, if the tenant 110 moves out before the end of the term specified in the lease, the tenant 110 may agree to pay rent for an additional period of time (e.g., two months after the tenant 110 moves out) so that it provides the landlord 120 (or the LGSP 130 if the lease guaranty policy of the landlord 120 covers it) some time to find a new tenant.

A settlement provides some relief to the landlord 120 but it may not cover the total loss caused by the breach. For instance, if the landlord 120 finds a new tenant within a period of time for which the tenant 110 pays the rent and the new tenant will pay the same rent, the rental income of the landlord 120 remains the same. In this case, the landlord 120 may not make a claim to the LGSP 130 if the lease guaranty policy does not cover the finding of a new tenant and if the cost of finding the new tenant is covered by the settlement with the tenant 110. However, if either the landlord 120 cannot identify another new tenant or the rent in the new lease is lower than the rent with the tenant 110, the landlord 120 may file a claim under the lease guaranty policy based on the actual loss due to the tenant's breach.

The landlord 120 may determine, at act 680, specifics related to a claim. For example, a claim amount may be determined according to either the court's judgment or the remaining amount owed after the settlement with the tenant 110. Alternatively, the lease guaranty policy of the landlord 120 may provide the LGSP 130 the ability to identify new tenant in case of early termination of the tenant. Once the specifics of the claim (e.g., amount of loss) are determined, the landlord 120 may then file, at act 690, the claim in compliance with the lease guaranty policy with the LGSP 130.

FIG. 7 is a flow of an exemplary business process (235), in which the LGSP 130 processes a claim in compliance with a lease guaranty policy and a lease guaranty participation agreement, according to an embodiment of the present invention. To be entitled to a claim, the landlord 120 may be required, under the lease guaranty policy, to fulfill certain contractual duties. When the LGSP 130 receives a claim from the landlord 120, it first examines, at act 700, whether the landlord 120 has fulfilled the pre-specified contractual duties. Such duties include, but are not limited to, notifying the breach (e.g., non-payment of rent) within a certain number of days after the breach, initiating a court (e.g., eviction) proceeding within a certain number of days after the first notification, and computing a claim amount according to what is required by the policy such as a court judgment, a settlement, or coverage of the lease guaranty policy.

If the landlord 120 does not fulfill the agreed contractual duties, the LGSP 130 refuses, at act 705, the claim. Otherwise, the LGSP 130 further examines, at act 710, whether the claim should be honored. There may be reasons by which the landlord 120 is not entitled to the claim. Such reasons or conditions may be explicitly specified in the lease guaranty policy or implied by law. For example, if the settlement between the tenant 110 and the landlord 120 violates certain terms of the lease guaranty participation agreement, the LGSP 130 may consider the claim invalid. If it is determined that the landlord 120 is not entitled to the claim, the RGS 130 refuses, at act 705, the claim.

If the landlord 120 both fulfills the contractual duties and all the conditions, explicitly specified or implied by law, the LGSP 130 honors, at act 715, the claim in compliance with the lease guaranty policy. This may include making payment to the landlord 120 according to the claim amount or taking action to locate a new tenant for the landlord 120 in case of early termination. The LGSP 130 updates, at act 720, corresponding records related to both the landlord 120 and the tenant 110. The LGSP 130 then initiates, at act 725, a collection procedure, pursuant to the lease guaranty participation agreement with the tenant 110, to collect payment from the tenant 110.

The collection amount may be determined according to both the amount of payment sent to the landlord 120 as well as the cost to find a new tenant (e.g., cost of placing an advertisement and other administrative cost at the LGSP 130). Depending on a specific situation, the collection amount may not necessarily equal the amount paid to the landlord 120. Collecting the cost of finding a new tenant is one example. There may be other situations where the collection amount is not the same as the claim amount. For example, if the landlord 120 receives additional payment for the rental property after the claim is honored, the collection amount is accordingly adjusted to a lower amount. Alternatively, adjustment needs to be made to the collection amount when an early terminated tenant has agreed to pay rent for a period of time after the rental property has been surrendered and subsequently the landlord 120 finds a new tenant during the period for which the breaching tenant 110 has paid rent (e.g., according to a settlement). Another possibility is that the rent under the new lease with the new tenant is higher than the previous rent. Different situations in which such overpayment has to be remitted may be explicitly defined in the lease guaranty policy and agreed to by both the landlord 120 and the LGSP 130.

If a payment is made to the landlord 120 after the claim is satisfied, determined at act 730, the LGSP 130 adjusts the collection amount, at acts 735, 740, and 745, by requesting the landlord 120 to remit the payment amount to the LGSP 130, changing the collection amount to subtract the payment amount, and updating the record to indicate a lower collection amount.

The collection procedure may be either carried out by the LGSP 130 (e.g., in-house collection department) or out-sourced to an independent collection agency or both (at different times). In the exemplary process described in FIG. 7, the LGSP 130 first carries out the collection, at act 750, via its own internal collection entity. Such effort may include activities such as (but not limited to) communicating with the breaching tenant or commencing legal proceedings. The collection effort conducted internally may be limited to a pre-defined period (e.g., 120 days after the claim amount is paid) and may be delegated, at act 775, to an independent collection agency after the pre-defined period.

During the collection procedure, the collection amount may be further adjusted. It may be determined, at act 755, whether there is a further payment made to the landlord 120 after the previous adjustment. If there is such a payment, the LGSP 130 adjusts the collection amount, at acts 760, 765, and 770, by requesting the landlord 120 to remit the payment amount to the LGSP 130, changing the collection amount to subtract the payment amount, and updating the record to indicate a lower collection amount.

FIG. 8 is a flow of an exemplary business process (240), in which the LGSP 130 processes the tenant's application to renew a lease guaranty participation agreement, according to an embodiment of the present invention. There may be different situations under which the tenant 110 wishes to renew the lease guaranty participation agreement. The tenant 110 may desire to renew the lease previously signed with the landlord 120. In this case, either the tenant 110 may wish to have a renewed lease guaranty participation agreement or the landlord 120 may require the tenant 110 to do so. As another example, the tenant 110 may have identified an additional rental property and wish to renew the previously entered lease guaranty participation agreement to cover this newly identified rental property. The newly identified rental property may or may not be associated with the landlord with whom the previous lease was signed.

When the tenant 110 decides to renew a previously entered lease guaranty participation agreement, the tenant 110 first submits, at act 800, a renewal application to the LGSP 130. Such application provides information to be used to approve the application such as the address of the rental property, the rent agreed with respect to the rental property, and the current income of the tenant 110. If the rental property is the same as before, the rent may be an accelerated rent amount. If it concerns a different rental property, the rent specifies the rent for the newly identified property.

Based on the provided information, the LGSP 130 performs, at act 820, the authorization check which may correspond to the same process as a pre-authorization application approval process as described with reference to FIG. 4. With the same authorization procedure, the tenant's renewal application may be refused due to different reasons. For example, the tenant's income may have changed since the previous lease guaranty participation agreement. The new rent may be too high so that the tenant's current income no longer qualifies the tenant for the rental property. If the renewal application is not approved, determined at act 830, the LGSP 130 refuses, at act 840, the tenant's application to renew the lease guaranty participation agreement. The tenant's record is then updated, at act 850, to indicate the renewal status. If deemed necessary or desired, the LGSP 130 may also issue a notice to the tenant 110 setting forth the refusal.

If the authorization check yields a result in favor of the tenant 110, the LGSP 130 updates, at act 860, the fee to be charged to the tenant 110 for the renewed lease guaranty participation agreement. This update may be determined according to various factors. For example, the tenant's previous records in terms of compliance with a lease and the previous lease guaranty participation agreement may be considered. The number of times the tenant 110 successfully renews the lease guaranty participation agreement may also be considered. Different discount levels in computing the updated fee for a renewed agreement may be explicitly specified and agreed in the previous lease guaranty participation agreement and applied in deriving the updated fee.

Using the updated fee for the approved new lease guaranty participation agreement, the LGSP 130 processes, at act 870, the renewed lease guaranty participation agreement and sends, at act 880, a certificate to the tenant 110 (maybe also to the landlord 120), indicating that the lease guaranty participation agreement has been renewed. The status of the renewed lease guaranty participation agreement is then recorded at act 850.

While the inventions have been described with reference to the certain illustrated embodiments, the words that have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather can be embodied in a wide variety of forms, some of which may be quite different from those of the disclosed embodiments, and extends to all equivalent structures, acts, and, materials, such as are within the scope of the appended claims.

1. A method, comprising:
entering an agreement between a landlord and a lease guaranty service provider, for a lease guaranty policy covering a rental property associated with the landlord, wherein the landlord is a beneficiary and is bound to at least one contractual duty under the lease guaranty policy;
applying, by a tenant, for a lease guaranty participation agreement with the lease guaranty service provider with respect to the rental property;
processing the tenant's lease guaranty participation agreement application; and
entering, between the lease guaranty service provider and the tenant, the lease guaranty participation agreement with respect to the rental property if the tenant's lease guaranty participation agreement application is approved, wherein
the lease guaranty participation agreement provides that the lease guaranty service provider, after receiving a valid claim from the landlord filed under the lease guaranty policy, pays the landlord a claim amount, resulting from the tenant's failure to comply with a lease signed between the tenant and the landlord with respect to the rental property, and the tenant is legally liable to the lease guaranty service provider.

2. The method according to claim 1, wherein said lease guaranty policy can be optionally in a form of a lease surety bond.

3. The method according to claim 1, wherein the lease guaranty policy covering the rental property provides guaranty in terms of at least one of:
monetary damage related to the rental property resulting from the tenant's breach of the lease; and
non-monetary damage related to the rental property resulting from the tenant's breach of the lease.

4. The method according to claim 3, wherein the monetary damage includes at least one of:
rent associated with the rental property, defined according to a specified unit of period; and
cost to repair property damages made to the rental property by the tenant.

5. The method according to claim 3, wherein the monetary damage is determined according to at least one of:
a court judgment; and
a settlement between the landlord and the tenant approved by the lease guaranty service provider.

6. The method according to claim 3, wherein the non-monetary damage includes finding a new tenant for the rental property when the lease is terminated earlier than an original term specified in the lease.

7. The method according to claim 6, wherein the lease is terminated earlier due to one of:
the tenant's earlier abandonment of the rental property;
an eviction of the tenant from the rental property because of the tenant's breach of one or more of the lease terms.

8. The method according to claim 1, wherein said entering an agreement comprises:
screening, by the lease guaranty service provider, the landlord; and
approving the landlord's request to sign up for the lease guaranty policy, if said screening yields a positive result.

9. The method according to claim 1, further comprising:
applying, by the tenant prior to said applying for the lease guaranty participation agreement, for a lease guaranty pre-authorization with the lease guaranty service provider;
processing, by the lease guaranty service provider, the lease guaranty pre-authorization application; and
identifying, by the tenant, the rental property using a lease guaranty pre-authorization.

10. The method according to claim 9, wherein said processing the lease guaranty pre-authorization application comprises:
checking the credit of the tenant;
accepting the tenant's application for the lease guaranty pre-authorization to issue the lease guaranty pre-authorization if said checking yields a positive result.

11. The method according to claim 10, further comprising:
examining the credential of the tenant according to additional criteria if said checking yields a partial positive result; and
accepting the tenant's application for the lease guaranty pre-authorization if the tenant satisfies the additional criteria.

12. The method according to claim 10, wherein the additional criteria include:
that the tenant's cash reserve exceeds a certain level; and
that the tenant's investment portfolio reaches a certain level.

13. The method according to claim 10, further comprising refusing the tenant's lease guaranty pre-authorization application if either that the credit check fails or that the tenant does not fully meet the additional criteria.

14. The method according to claim 1, wherein said processing the lease guaranty participation agreement application comprises:
examining, by the lease guaranty service provider, whether the tenant has a valid previously issued lease guaranty pre-authorization;
performing lease guaranty authorization if the tenant does not have a valid previously issued lease guaranty authorization;
verifying information relevant in evaluating the lease guaranty participation agreement application; and
issuing a document certifying the lease guaranty participation agreement if said verification yields a positive result.

15. The method according to claim 14, wherein said performing lease guaranty authorization comprises:
checking the credit of the tenant;
authorizing the lease guaranty authorization application subject to further verification if said checking yields a positive result.

16. The method according to claim 15, further comprising:
examining the credential of the tenant according to additional criteria if said checking yields a partial positive result; and
authorizing the lease guaranty authorization application subject to further verification if the tenant satisfies the additional criteria.

17. The method according to claim 14, wherein the information relevant to the evaluation includes at least one of:
identification of the tenant; and
tenant's income;
the address of the rental property; and
rent for the rental property.

18.. The method according to claim 1, wherein said entering the lease guaranty participation agreement comprises:
executing the lease guaranty participation agreement prior to, or simultaneous with the execution of the lease; and
signing a lease between the landlord and the tenant for the rental property.

19. The method according to claim 1, further comprising:
submitting, by the landlord after the tenant and the lease guaranty service provider enter into the lease guaranty participation agreement, a claim under the lease guaranty policy with a claim amount if the tenant fails to comply with the lease with respect to the rental property;
processing, by the lease guaranty service provider, the claim in compliance with the lease guaranty policy and the lease guaranty participation agreement.

20. The method according to claim 19, further comprising performing, by the landlord prior to said submitting, the at least one contractual duty that the landlord is bound under the lease guaranty policy.

21. The method according to claim 20, wherein the at least one contractual duty includes at least one of:
sending, by the landlord, a notification to the tenant and the lease guaranty service provider indicating a breach;
initiating an eviction proceeding if the breach persists after the tenant receives the notification; and
determining the claim amount based on one of a court judgment from the eviction proceeding and a settlement agreed between the landlord and the tenant approved by the lease guaranty service provider.

22. The method according to claim 19, wherein said processing the claim comprises:
examining whether the landlord fulfills the at least one contractual duty under the lease guaranty policy;
sending the claim amount to the landlord if the landlord fulfills the at least one contractual duty; and
commencing a collection procedure to collect a collection amount from the tenant, wherein the collection amount is determined based on the claim amount.

23. The method according to claim 22, wherein the collection procedure comprises:
examining whether there is a payment made to the landlord for the rental property after the claim amount is paid to the landlord;
adjusting the collection amount to generate an updated collection amount if the landlord receives a payment for the rental property after the landlord receives the claim amount; and
performing the collection for the updated collection amount.

24. The method according to claim 23, wherein said adjusting comprises:
requesting the landlord to remit the payment amount; and
generating the updated collection amount by subtracting, from the collection amount, the payment amount.

25. The method according to claim 23, wherein said performing the collection comprises:
conducting in-house collection within a pre-determined period; and
delegating a collection agency to continue the collection if the tenant does not pay the collection amount after the pre-determined period.

26. The method according to claim 25, further comprising adjusting the collection amount if the tenant makes a payment to the landlord during said performing the collection.

27. The method according to claim 22, further comprising refusing the claim if the landlord fails to satisfy the conditions that entitle the landlord to the claim under the lease guaranty policy.

28. The method according to claim 1, further comprising entering into a renewed lease guaranty participation agreement between the tenant and the lease guaranty service provider when the lease guaranty participation agreement expires.

29. The method according to claim 28, wherein said entering a renewed lease guaranty participation agreement comprises:
submitting, by the tenant, a renewal application to the lease guaranty service provider;
performing authorization check;
executing the renewed lease guaranty participation agreement between the tenant and the lease guaranty service if the authorization check yields a positive result; and
issuing a document to the tenant and to the landlord certifying that the renewal application is approved.

30. A method for a landlord, comprising:
entering an agreement , with a lease guaranty service provider, for a lease guaranty policy covering a rental property associated with the landlord, wherein the landlord is a beneficiary and is bound to at least one contractual duty under the lease guaranty policy;
entering into a lease with a tenant on the rental property, wherein
the tenant is under a lease guaranty participation agreement with the lease guaranty service provider with respect to the rental property and the lease guaranty participation agreement provides that the lease guaranty service provider, after receiving a valid claim from the landlord filed under the lease guaranty policy, pays the landlord a claim amount, resulting from the tenant's failure to comply with the lease for the rental property, and the tenant is legally liable to the lease guaranty service provider.

31. The method according to claim 30, further comprising submitting a claim under the lease guaranty policy with a claim amount when the tenant, after the lease is signed, fails to comply with the lease.

32. The method according claim 31, further comprising performing the at least one contractual duty to which the landlord is bound under the lease guaranty policy prior to said submitting.

33. The method according to claim 32, wherein the at least one contractual duty includes at least one of:
sending a notification to the tenant and the lease guaranty service provider indicating a breach;
initiating an eviction proceeding if the breach persists after the tenant receives the notification; and
determining the claim amount based on one of a court judgment from the eviction proceeding and a settlement agreed between the landlord and the tenant.

34. The method according to claim 31, further comprising receiving the claim amount from the lease guaranty service provider.

35. The method according to claim 34, further comprising receiving a payment for the rental property after the claim amount is received.

36. The method according to claim 35, further comprising receiving a request from the lease guaranty service provider to remit the amount of the payment to the lease guaranty service provider.

37. The method according to claim 36, further comprising remitting the payment amount to the lease guaranty service provider.

38. A method for a tenant, comprising:
applying for a lease guaranty participation agreement with a lease guaranty service provider with respect to a rental property associated with a landlord, wherein the landlord has a lease guaranty policy from the lease guaranty service provider that covers the rental property; and
entering, if the tenant's lease guaranty participation agreement application is approved, into the lease guaranty participation agreement with the lease guaranty service provider after the tenant and the landlord sign a lease on the rental property, wherein
the lease guaranty participation agreement provides that the lease guaranty service provider, after receiving a valid claim from the landlord filed under the lease guaranty policy, pays the landlord a claim amount, resulting from the tenant's failure to comply with the lease for the rental property, and the tenant is legally liable to the lease guaranty service provider.

39. The method according to claim 38, further comprising:
applying, prior to said applying for the lease guaranty participation agreement, for a lease guaranty pre-authorization from the lease guaranty service provider; and
identifying, after the lease guaranty service provider issues the lease guaranty pre-authorization application, the rental property using the lease guaranty pre-authorization.

40. The method according to claim 38, further comprising receiving a first notification from the landlord indicating a breach of the lease.

41. The method according to claim 40, further comprising receiving a second notification of an eviction proceeding initiated by the landlord after the first notification.

42. The method according to claim 41, further comprising receiving a collection notification to demand a collection amount, wherein the collection amount is determined based on a claim amount that the lease guaranty service provider pays to the landlord under the lease guaranty policy and the claim amount is determined according to one of a judgment from a court and a settlement agreed between the tenant and the landlord.

43. The method according to claim 42, wherein the collection notification is received from one of:
the lease guaranty service provider; and
a collection agency.

44. A method for a lease guaranty service provider, comprising:
receiving a first request from a landlord to sign up for a lease guaranty policy covering a rental property associated with the landlord;
processing the landlord's request;
allowing the landlord to sign up for the lease guaranty policy, if the processing yields a positive result, wherein the landlord is a beneficiary and is bound to at least one contractual duty under the lease guaranty policy;
receiving a second request from a tenant to apply for a lease guaranty participation agreement with respect to the rental property; and
entering the lease guaranty participation agreement with the tenant when the tenant's lease guaranty participation agreement application is approved, wherein
the lease guaranty participation agreement provides that the lease guaranty service provider, after receiving a valid claim from the landlord filed under the lease guaranty policy, pays the landlord a claim amount, resulting from the tenant's failure to comply with a lease for the rental property signed between the landlord and the tenant, and the tenant is legally liable to the lease guaranty service provider.

45. The method according to claim 44, wherein said processing comprises:
screening, upon receiving the first request, the landlord with respect to the rental property; and
approving the first request of the landlord for signing up for the lease guaranty policy.

46. The method according to claim 45, further comprising:
receiving an application, from the tenant prior to the tenant's application for the lease guaranty participation agreement, for a lease guaranty pre-authorization with the lease guaranty service provider;
processing the lease guaranty pre-authorization application; and
issuing the lease guaranty pre-authorization to the tenant if said processing yields a positive result.

47. The method according to claim 45, wherein said entering the lease guaranty participation agreement comprises:
performing lease guaranty pre-authorization if the tenant does not have a valid previously issued lease guaranty pre-authorization;
verifying information relevant to the evaluation of the lease guaranty participation agreement application;
issuing a document certifying the lease guaranty participation agreement if said verification yields a positive result;
signing the lease between the landlord and the tenant for the rental property; and
executing the lease guaranty participation agreement prior to, simultaneous, or after the lease is signed.

48. The method according to claim 47, wherein the information relevant to the evaluation includes at least one of:
identification of the tenant; and
tenant's income;
the address of the rental property; and
rent for the rental property.

49. The method according to claim 45, further comprising:
receiving a claim with a claim amount, submitted by the landlord under the lease guaranty policy after the tenant fails to comply with the lease after the tenant and the lease guaranty service provider enter into the lease guaranty participation agreement;
processing the claim in compliance with the lease guaranty policy and the lease guaranty participation agreement.

50. The method according to claim 49, wherein said processing the claim comprises:
examining whether the landlord fulfilled the at least one contractual duty;
sending the claim amount to the landlord if the landlord fulfilled the at least one contractual duty; and
commencing a collection procedure under the lease guaranty participation agreement to collect a collection amount from the tenant, wherein the collection amount is determined based on the claim amount.

51. The method according to claim 50, wherein the collection procedure comprises:
examining whether there is a payment made to the landlord for the rental property after the claim amount is paid to the landlord;
adjusting the collection amount to generate an updated collection amount if the landlord receives the payment for the rental property after the landlord receives the claim amount; and
performing collection for the updated collection amount.

52. The method according to claim 51, wherein said adjusting comprises:
requesting the landlord to remit the amount of the payment; and
generating the updated collection amount by subtracting, from the collection amount, the payment amount.

53. The method according to claim 51, wherein said performing collection comprises:
conducting in-house collection within a pre-determined period; and
delegating a collection agency to continue the collection if the tenant fails to pay the lease guaranty service provider for the collection amount after the pre-determined period.

54. The method according to claim 53, further comprising adjusting the collection amount if the tenant makes a payment to the landlord during said performing collection.

55. The method according to claim 45, further comprising entering a renewed lease guaranty participation agreement between the tenant and the lease guaranty service provider after the lease guaranty participation agreement expires.

56. The method according to claim 55, wherein said entering a renewed lease guaranty participation agreement comprises:
receiving a renewal application from the tenant;
verifying information used to evaluate the renewal application;
performing authorization check;
executing the renewed lease guaranty participation agreement between the tenant and the lease guaranty service provider if said authorization check yields a positive result; and
issuing a document to the tenant and to the landlord certifying that the renewal application is approved.

57. A framework, comprising:
a landlord having a rental property;
a tenant seeking to rent the rental property; and
a lease guaranty service provider, offering lease guaranty services, wherein
the landlord signs up with the lease guaranty service provider for a lease guaranty policy covering the rental property, under which the landlord is a beneficiary and is bound to at least one contractual duty, and
the tenant enters a lease guaranty participation agreement with the lease guaranty service provider with respect to the rental property, which provides that the lease guaranty service provider, after receiving a valid claim from the landlord filed under the lease guaranty policy, pays the landlord a claim amount, resulting from the tenant's failure to comply with a lease signed between the tenant and the landlord for the rental property, and the tenant is legally liable to the lease guaranty service provider.

58. The framework according to claim 57, further comprising at least one of:
a credit agency capable of providing credit information to the lease guaranty service provider; and
a public information source capable of providing information useful in screening the landlord.
